(19) United States
(12) Patent Application Publication
(10) Pub. No.: US 2004/0035260 A1
(43) Pub. Date: Feb. 26, 2004

(54) Tool with engaging portion having axial opening and radial slot

(76) Inventor: O. Gemare Adkison, Gadsden, AL (US)

Correspondence Address: Richard C. Litman, LITMAN LAW OFFICES, LTD., P.O. Box 15035, Arlington, VA, 22215, US

(21) Appl. No.: 10/643,971

(22) Filed: Aug. 20, 2003

Related U.S. Application Data
(60) Provisional application No. 60/404,763, filed on Aug. 21, 2002.

(51) Int. Cl. B25B 13/00

(52) U.S. Cl. 81/124.2

(57) ABSTRACT

A tool having a handle, shaft, and an engaging portion with a first end and a second end, the first end connected to the shaft. The engaging portion has a slot extending from the first end to the second end thereby defining an axial inner surface, the axial inner surface having a plurality of engaging surfaces. Alternatively, the tool is a wrench generally cylindrical in shape of one-piece construction, having a first end, a second end, an engaging portion disposed both the first second ends, and a slot extending between the first and second ends. The first end has a plurality of axial engaging surfaces and a plurality of notches penetrating the wall of the tool. The second end has a plurality of tapered engaging surfaces thereby decreasing the size of the opening away from end.

### CROSS-REFERENCE TO RELATED APPLICATION

This application claims the benefit of U.S. Provisional Patent Application Serial No. 60/404,763, filed Aug. 21, 2002.

### BACKGROUND OF THE INVENTION

1. Field of the Invention

The present invention relates to a tool, and particularly to a wrench having at least one engaging portion, the wrench having an axial opening and a radial slot which may be used for many purposes including, but not limited to, tightening and loosening any standard (metric, standard, etc.) connector or fastening device such as a bathroom faucet nut, threaded nut, a threaded bolt, a spark plug, an engine head bolt, an automotive gas line, and an automotive brake line.

2. Description of Related Art

Plumbers, mechanics, homeowners, carpenters, maintenance workers and tradespersons in many industries commonly use connectors to attach two members together. Often, such connectors are located in hard-to-reach spaces with limited working space near the connector. Also, such connectors may be used in combination with a linear member, such as a water line in plumbing or a brake line in automotive mechanics. Particularly in performing maintenance, a tradesperson may encounter a connector, which was easy to reach during the initial installation of the connector, but has become hard-to-reach due to the subsequent installation of an intervening object.

For example, in plumbing, when a sink or lavatory is first installed, the water lines are attached with connectors before installation of the basin. Prior to installation of the basin, the connectors attaching the water line to the sink or lavatory is easy to reach; however, after installation of the basin, a small space is left between the basin and the cabinet or wall. Common plumbing tasks, such as repairing or replacing a faucet, require the removal and reattachment of these water lines. Because removal of the basin is time consuming and impractical, the only way to access the connector attaching the water line to the sink or lavatory is by approaching the connector from below through a tight space, however, due to the presence of the water line, the actual engagement with the connector can only happen from the side. The space to either side of the connector is often insufficient in size to allow the use of a conventional wrench. There is often fewer than a few inches of horizontal space to maneuver a tool for this task.

Similarly, in automotive mechanics, a common task is removal and reattachment of a gas line or a brake line, which involves a linear member attached with a connector at one end of the line. As with plumbing, there is often limited space to allow use of a conventional wrench.

Various tools have been devised to access connectors in hard-to-reach spaces. However, many of these tools typically include engaging ends with multiple parts and a large cross-sectional area when measured in a direction perpendicular to the axis of the tool. The large cross-sectional area leads to at least two major problems: the tool is difficult to use in tight spaces and the engaging end of the tool is heavy thus fatiguing the user. Furthermore, many of these tools have multiple parts, making it expensive to manufacture and easy to damage or break. In addition, many of these tools do not permit a firm engagement with the connector in a direction parallel to the shaft of the tool, thereby allowing the connectors to slip off the tool, thus making use of the tool difficult and time consuming. Furthermore, the difficulty in using these tools often leads to the user becoming fatigued and prone to injure their knuckles or hands during operation of the tool.

For example, U.S. Pat. No. 4,485,702, issued Dec. 4, 1984 to Swan et al., discloses a basin wrench having a telescoping handle and a spring loaded movable jaw for clamping a nut or pipe against a gripping face. The movable jaw and gripping face may be rotated about a shaft. The '702 patent also discloses a positive action basin wrench with additional features and an even bulkier and more complicated engaging end. While effective, both wrenches have engaging ends with multiple parts. These engaging ends have large cross-sectional areas when measured in a direction perpendicular to the axis of the tool that are difficult to use in tight spaces. Due to the complexity of the tools, they are expensive to manufacture and not very durable. Furthermore, the wrench disclosed in the '702 patent does not permit a firm engagement with the connector in a direction parallel to the shaft of the tool. The only surfaces engaging with the connector are the movable jaw and the gripping face or fixed jaw. There is no support for the connector in a direction parallel to the shaft of the tool. Consequently, the jaw may tend to slip off of the fastener.

U.S. Pat. No. 4,928,559, issued May 29, 1990 to Stielow, discloses a ratchet wrench with a wrench body portion and a nut driver. The wrench body portion has a hole into which the nut driver rests. The nut driver has a hole and a sleeve insert. The hole has a hexagonal-shaped (six-sided) periphery in nut driver upper portion and a circular periphery in nut driver lower portion. The sleeve insert engages tightening nuts. The wrench body portion also includes a passageway or gap portion and the nut driver has an opening or passageway; however, in order for the ratchet wrench to function, a detachable wedge portion must first be attached into the opening or passageway.

Although effective, the Stielow wrench suffers from the same limitation as the wrench disclosed in the '702 patent in that the wrench body portion and nut driver have a large cross-sectional area when measured in a direction perpendicular to the axis of the tool that is difficult to use in tight spaces. Furthermore, the wrench disclosed by Stielow is complicated, making it expensive to manufacture and easy to break. The shape of the hole only provides for a hexagonal-shaped (six-sided) periphery at one end and a circular periphery at the other, so that it is not possible to engage connectors with tapered connections to linear members, as with a flare wrench. Furthermore, the Stielow wrench is not functional without the additional step of attaching the detachable wedge portion after engagement of the tool with a connector.

U.S. Pat. No. 5,251,519, issued Oct. 12, 1993 to Lang, discloses a T-handle wrench kit with a handle and an operational block that secures a removable head. As with Swan, the Lang wrench has a large cross-sectional area at its engaging end when measured in a direction perpendicular to the axis of the tool, is expensive to manufacture, may break easily and there is no support for the connector in a direction parallel to the shaft of the tool.

Other patents showing wrenches for engaging connectors include U.S. Pat. No. 95,908, issued Oct. 19, 1869 to W. H. Johnson (plumber=s tool; improvement in wash-pave key-handle); U.S. Pat. No. 1,349,553, issued Aug. 17, 1920 to J. R. Ayotte (hand tool); U.S. Pat. No. 1,521,464, issued Dec. 30, 1924 to R. E. Miller (wrench); U.S. Pat. No. 1,677,473, issued Jul. 17, 1928 to W. W. Gast (socket wrench and screw driver); U.S. Pat. No. 1,885,593, issued Nov. 1, 1932 to A. J. Downer (under pressure faucet and valve tool); U.S. Pat. No. 2,491,623, issued Dec. 20, 1949 to S. G. Sesak (basin wrench having rotatably adjustable inner-jaw and multiaxis-pivoted outer-jaw); U.S. Pat. No. 2,263,508, issued Nov. 18, 1941 to A. Lee (extension handle assembly); U.S. Pat. No. 4,852,192, issued Aug. 1, 1989 to Viegener (faucet assembly plumbing fixture); U.S. Pat. No. 5,048,378, issued Sep. 17, 1991 to Nikolas (tool and method for faucet nut installation); U.S. Pat. No. 5,050,463, issued Sep. 24, 1991 to Stielow (ratchet wrench); and U.S. Pat. No. 5,519,929, issued May 28, 1996 to Bleckman (tool for removing faucet compression gasket).

None of the above inventions and patents, taken either singly or in combination, is seen to describe the instant invention as claimed. Thus, a tool solving the aforementioned problems is desired.

### SUMMARY OF THE INVENTION

In order to solve the problems associated with the prior art tools discussed above, a tool with an engaging portion having an axial opening and a radial slot has been devised. The tool may be used for many purposes including but not limited to tightening and loosening any standard (metric, English, etc.) connector or fastening device such as a threaded nut, a threaded bolt, a spark plug, an engine head bolt, an automotive gas line, and an automotive brake line. The tool is particularly useful for engaging a connector, which is located in a hard-to-reach space with limited working space near the connector, particularly where a conventional wrench cannot be used. The tool of the present invention does not require the fabrication of multiple parts, is simple and inexpensive to manufacture, is durable, has a compact engaging end making it easy to use in tight spaces, permits a firm engagement with a connector in a direction parallel to the shaft of the tool, and may be formed with different types of engaging surfaces for engaging different types of connectors.

The present invention is a tool with an engaging portion having an axial opening and a radial slot. The tool comprises a handle, a shaft comprising a shaft axis connected to the handle, and an engaging portion comprising an engaging portion axis, a first end and a second end. The first end is connected to the shaft. The engaging portion comprises an opening extending from the first end to the second end thereby defining an axially inner surface of the engaging portion and an axially outer surface of the engaging portion. The opening comprises a first portion at the first end with a first opening area and a second portion at the second end with a second opening area.

The first opening area may be adapted to engage with a standard ratchet. The first opening area may be smaller than the second opening area. The engaging portion further comprises a slot extending from the axially inner surface to the axially outer surface, and the second end of the axially inner surface comprises a plurality of engaging surfaces. The shaft and the engaging portion of the tool may be of one-piece construction.

The tool may optionally have an engaging portion with various geometries comprising various configurations of engaging surfaces. The engaging portion may be adapted to engage with any size connector using any standard. The tool may be provided such that the shaft axis is offset from the engaging portion axis. The tool may be provided such that the opening further comprises an inner portion of the axially inner surface which is located between the first portion and the engaging surfaces, the inner portion comprises a third opening area, and the third opening area is smaller than the second opening area thus forming a seat. The intersection of any two engaging surfaces may be referred to as a point. The tool may be provided with the engaging portion comprising any number of points arranged in an arc about the engaging portion axis.

In another embodiment of the invention, a tool is provided which is substantially similar to the embodiment described above except that an engaging portion has a shorter depth when measured in the direction parallel to the engaging portion axis as compared to the embodiment described above. The second embodiment of the tool comprises a handle, a shaft comprising a shaft axis connected to the handle, and an engaging portion comprising an engaging portion axis, a first end and a second end. The first end is connected to the shaft. The engaging portion comprises an opening extending from the first end to the second end thereby defining an axially inner surface of the engaging portion and an axially outer surface of the engaging portion. The engaging portion comprises a slot extending from the axially inner surface to the axially outer surface. The axially inner surface comprises a plurality of engaging surfaces.

The tool may optionally have an engaging portion with various geometries comprising various configurations of engaging surfaces. The shaft and the engaging portion of the tool may be of one-piece construction. The axially inner surface of the tool may comprise any number of equally sized engaging surfaces. The shaft axis of the tool may be offset from the engaging portion axis. The engaging portion and the engaging surfaces of the tool may be adapted to allow engagement with a standard sized connector. The engaging portion of the tool may comprise any number of points arranged in an arc about the engaging portion axis. The slot of the tool may be adapted to accommodate a linear member attached to a connector. The slot of the tool may be adapted to accommodate a standard sized water line for a sink or a lavatory by means of a connector.

In another embodiment of the invention, a tool is provided which is substantially similar to the embodiments described above except that no handle is provided, and there is a second engaging portion. Substantially cylindrical in shape with a slot extending its length, the second engaging portion has a plurality of tapering engaging surfaces, the axial opening getting smaller away from the end. Furthermore, the first end has notches disposed thereon for cooperatively engaging wing nut connectors, which are common on bathroom fixtures.

Accordingly, it is a principal object of the invention to provide a tool for tightening and loosening standard connectors or fastening devices.

It is a further object of the invention to provide a tool for use in plumbing, automotive, locomotive, aerospace, shipbuilding, and farming.

It is another object of the invention to provide a tool for tightening and loosening a spark plug, an engine head bolt, an automotive gas line, or an automotive brake line.

Still another object of the invention is to provide a tool for engaging a connector, which is located in a hard-to-reach space with limited working space near the connector, particularly where a conventional wrench cannot be used.

It is a further object of the invention to provide a tool with a small cross-sectional area when measured in a direction perpendicular to the axis of the tool.

It is another object of the invention to provide a lightweight tool easily manipulated in close quarters.

Still another object of the invention is to provide a tool, which is inexpensive to manufacture.

It is a further object of the invention to provide a tool with one-piece construction, which is durable and difficult to damage or break.

It is another object of the invention to provide a tool, which permits a firm engagement with a connector in a direction parallel to the shaft of the tool.

Still another object of the invention is to provide a tool that prevents fatigue or injury of the user's knuckles or hands during operation of the tool.

It is a further object of the invention to provide a tool adapted to attach or remove a linear member attached to a connector.

It is another object of the invention to provide a tool adapted to accommodate a standard sized water line for a sink or a lavatory by means of a connector having a tapered head.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a tool with an engaging portion having an axial opening and a radial slot according to the present invention engaged with a linear member and a connector.

FIG. 2 is an environmental, perspective view of a tool with an engaging portion having an axial opening and a radial slot with further emphasis on the engaging portion.

FIG. 3 is an environmental, perspective view with emphasis on the engaging portion and the optional engagement of a ratchet with the first end of the engaging portion.

FIG. 4 is an end view of a second end of the engaging portion with 8 engaging surfaces engaging a connector and a slot, which is about 33% open.

FIG. 5 is an end view of an alternate version of the second end of the engaging portion with 5 engaging surfaces engaging a connector and a slot that is about 17% open.

FIG. 6 is an end view of the second end of the engaging portion shown in FIG. 4 without the connector showing an inner portion with a third area and a seat formed in the engaging portion.

FIG. 7 is an end view of the alternate version of the second end of the engaging portion shown in FIG. 5 without the connector showing an inner portion with a third area and a seat formed in the engaging portion.

FIG. 8 is an environmental, perspective view of another embodiment of the present invention showing a tool with an engaging portion having an axial opening and a radial slot.

FIG. 9 is an environmental, perspective view of another embodiment of the present invention showing a cylindrical wrench having two axial openings and engaging surfaces disposed on either end, and a radial slot extending from the first end to the other end, the wrench being used to remove a water line connector.

FIG. 10 is a detailed perspective view of the present invention according to FIG. 9.

FIG. 11 is an end view of a first end of the tool according to FIG. 9, detailing the axial opening forming a multi-faceted engaging surface, having a radial slot and notched engaging surfaces.

FIG. 12 is an end view of the second end of the tool according to FIG. 9, detailing the axial opening forming a tapered engaging surface with a radial slot.

Similar reference characters denote corresponding features consistently throughout the attached drawings.

### DETAILED DESCRIPTION OF THE PREFERRED EMBODIMENTS

The present invention is a tool with an engaging portion having at least one axial opening and a radial slot. The tool may be used for many purposes including but not limited to tightening and loosening any standard (metric, English, etc.) connector or fastening device such as a threaded nut, a threaded bolt, a spark plug, an engine head bolt, an automotive gas line, and an automotive brake line. The tool can be used in various industries including but not limited to plumbing, automotive, locomotive, aerospace, shipbuilding, and farming. The tool is particularly useful for engaging a connector, which is located in a hard-to-reach space with limited working space near the connector, particularly where a conventional wrench cannot be used.

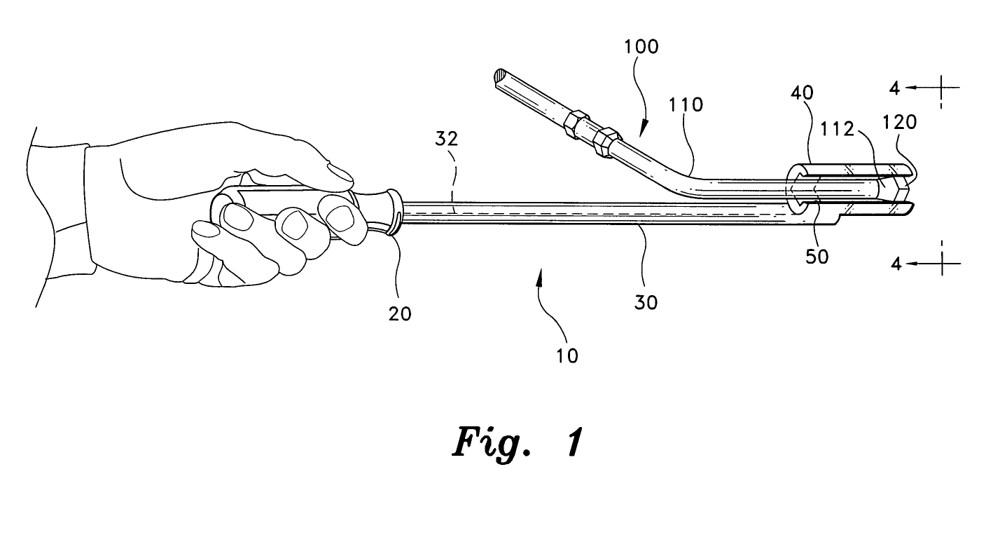

A first embodiment of the invention is generally described as 10 in FIGS. 1-7, and, as shown in FIG. 1, may be used to attach a roughly linear member 100, such as a water line 110 used in plumbing, to a sink or lavatory by means of connector 120. Connectors may be of any type. Typically, such connectors 120 are commonly 6-sided nuts or bolts. The present invention may be adapted for use with other types of connectors in accordance with the teachings of the present invention.

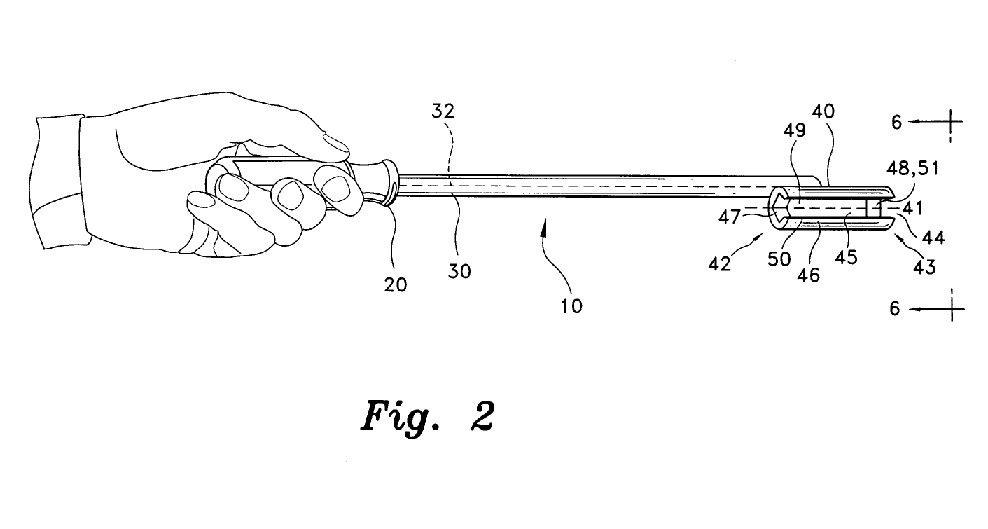

As shown in FIGS. 1 and 2, the tool 10 comprises a handle 20. In the figures, the handle 20 is shown with a screwdriver type handle; however, the handle 20 may be any type for use by a human user or in combination with another tool or machine, such as a ratchet or power tool. The handle 20 may be composed of any suitable material such as hard plastic. If the tool 10 is to be adapted for human use, the handle 20 may be a common sized handle with a common grip.

The tool 10 further comprises a shaft 30 comprising a shaft axis 32 connected to the handle 20. Although the shaft 30 is shown with a circular cross-section, the shaft 30 may be any geometric shape. The shaft 30 may be composed of any suitable material such as steel. For the specific purpose of attaching a water line 110 to a sink by means of a connector 120, the shaft 30 may be between 4″ and 12″ in length when measured along the shaft axis 32. Smaller or larger dimensions of the shaft 30 may be provided for smaller or larger connectors.

The tool 10 further comprises an engaging portion 40 comprising an engaging portion axis 41, a first end 42 and a second end 43. The first end 42 is connected to the shaft 30. The engaging portion 40 is shown with a substantially cylindrical shape; however, any suitable shape may be used. For the specific purpose of attaching a water line 110 to a sink by means of a connector 120, the engaging portion 40 may be between 2″ and 3¼″ in length when measured along the engaging portion axis 41, and the outside diameter may be between 1⅛″ (for engaging with a ¾″ connector) and 1 5/16″ (for engaging with a 15/16″ connector). Smaller or larger dimensions of the engaging portion 40 may be provided for smaller or larger connectors, respectively.

The overall length of the embodiment of the tool 10 for the specific purpose of attaching a water line 110 to a sink by means of a connector 120 may be between 9″ and 18″. Again, smaller or larger dimensions of the tool 10 may be provided for smaller or larger connectors or different working conditions.

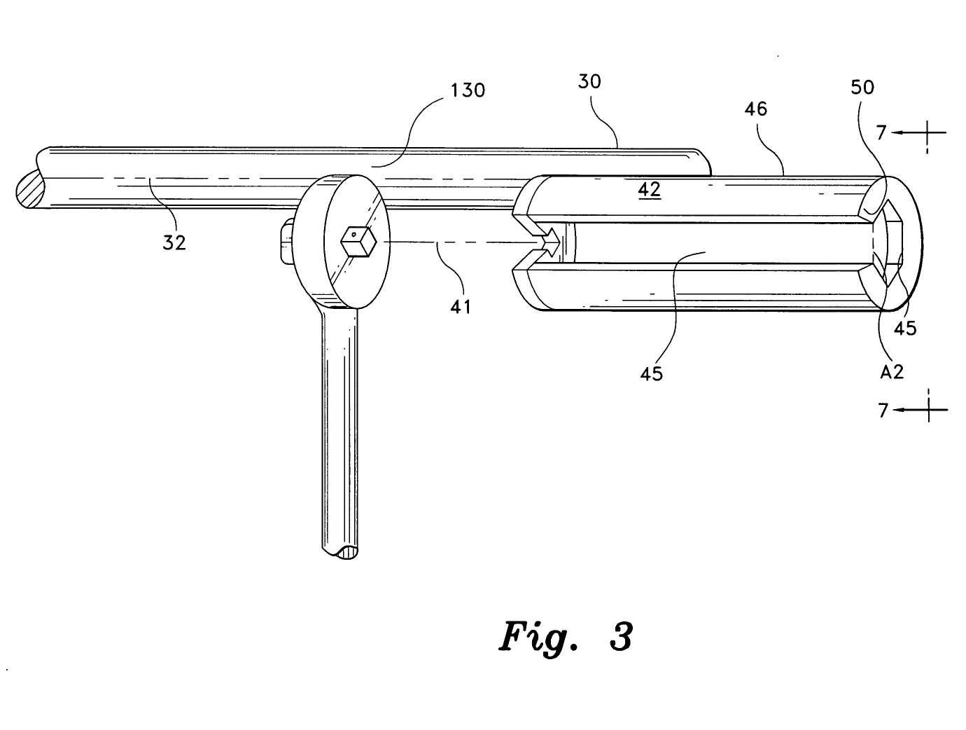

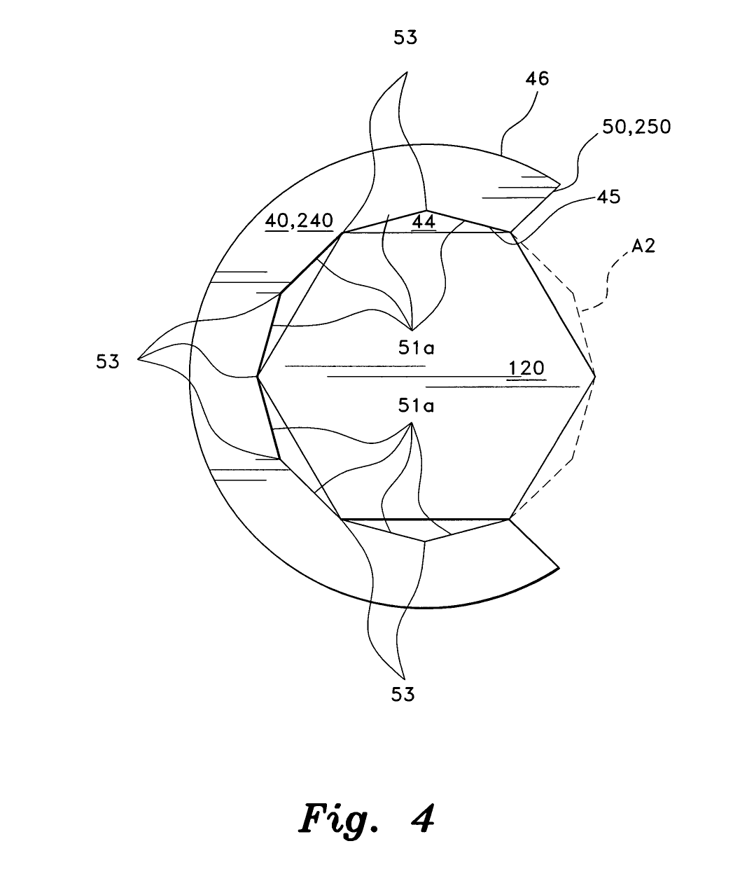

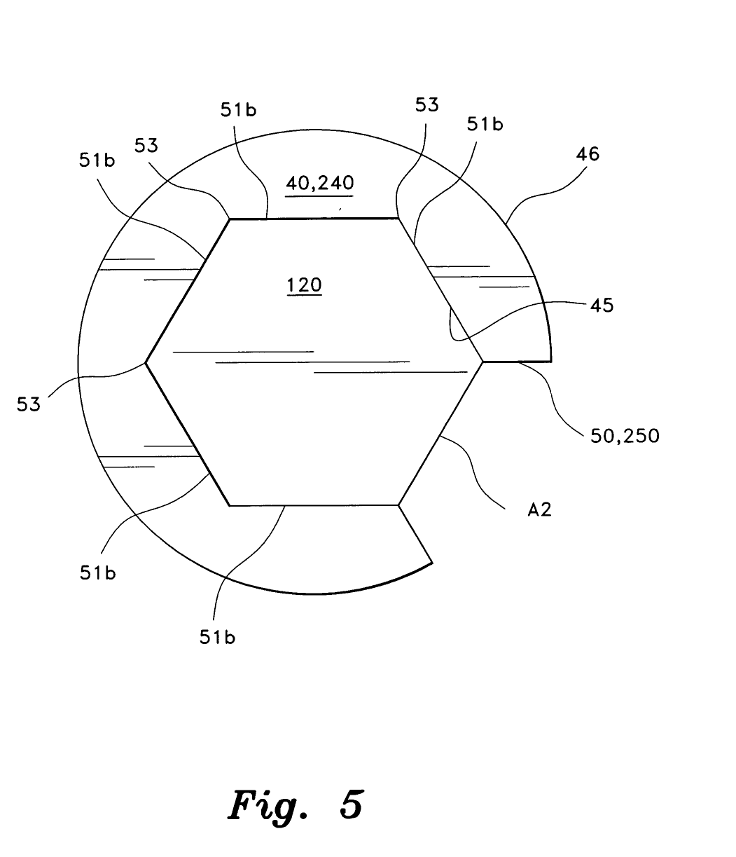

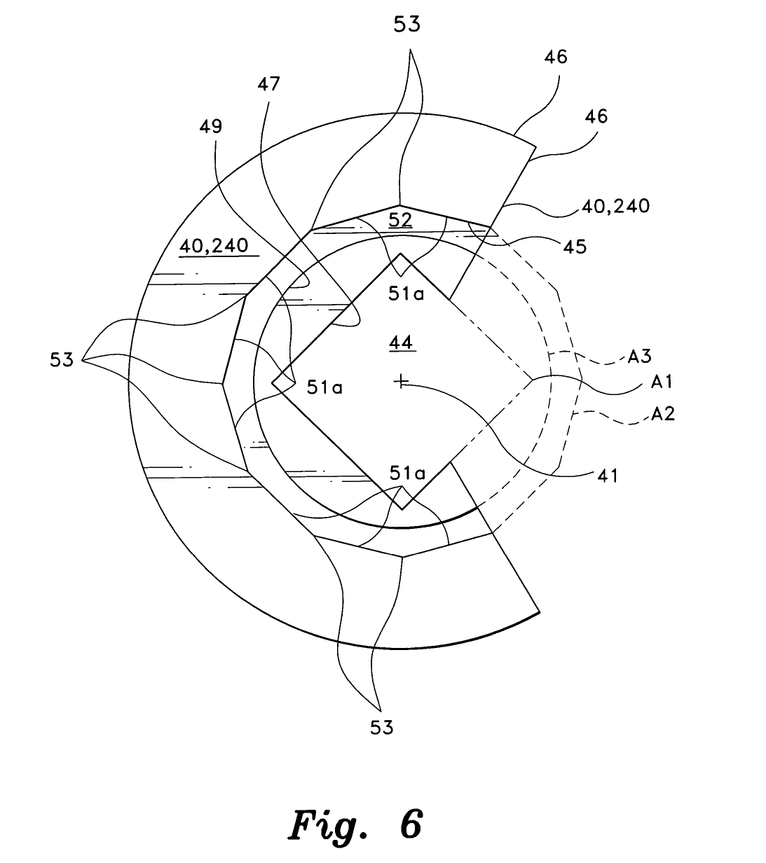

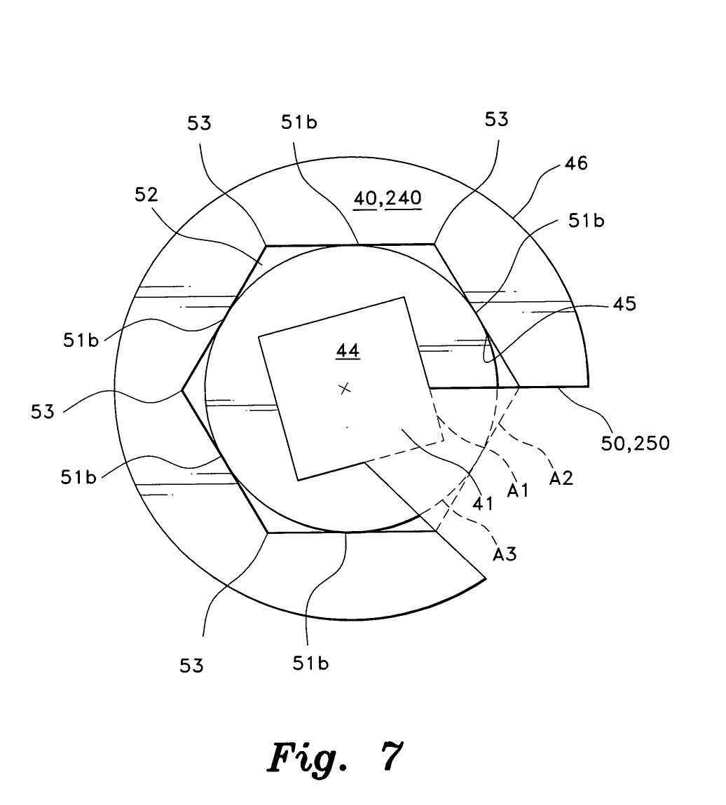

The engaging portion 40 comprises an opening 44 extending from the first end 42 to the second end 43 thereby defining an axially inner surface 45 of the engaging portion 40 and an axially outer surface 46 of the engaging portion 40. The opening 44 comprises a first portion 47 at the first end 42 with a first opening area A1 (see FIGS. 6 and 7) and a second portion 48 at the second end 43 with a second opening area A2 (see FIGS. 4-7). As shown in FIGS. 6 and 7, opening 44 substantially forms the first opening area A1 and the remainder is shown with a dotted line as an extension of the opening 44. The first opening area A1 is shown as square in shape, but may be of any suitable geometry. As shown in FIG. 3, the first opening area A1 may be adapted to engage with a standard ratchet 130. As shown in FIG. 4, opening 44 substantially forms the second opening area A2 and the remainder is shown with a dotted line as an extension of the opening 44. The second opening area A2 is shown as a 12-sided shape in FIGS. 4 and 6 and as a 6-sided shape in FIGS. 5 and 7, but the second opening area may be of any suitable geometry.

The first opening area A1 may be smaller than the second opening area A2. In the specific case of attaching a water line 110 by means of a connector 120, the water line 110 often includes a tapered portion 112 (see FIG. 1). Accordingly, by providing that the first opening area A1 is smaller than the second opening area A2, the engaging portion 40 of the present invention may be adapted to accommodate the tapered portion 112 of a water line 110.

As seen best in FIG. 2, the engaging portion 40 further comprises a slot 50 extending from the axially inner surface 45 to the axially outer surface 46, and the second end 43 of the axially inner surface 45 comprises a plurality of engaging surfaces 51. The second end 43 of the axially inner surface 45 may comprise any number of equally sized engaging surfaces 51. The particular characteristics of the slot 50 are discussed in greater detail below.

The shaft 30 and the engaging portion 40 of the tool 10 may be of one-piece construction. A one-piece construction may be accomplished by any suitable method including molding or die-casting.

As seen best in FIGS. 4 through 7, the tool 10 may optionally have an engaging portion 40 with various geometries comprising various configurations of engaging surfaces 51a, 51b.

In FIG. 4, the tool 10 is provided such that the engaging portion 40 has 8 equally sized linear engaging surfaces 51a and the slot 50 comprises about 33% of the circumference of the engaging portion 40. The engaging portion 40 shown in FIG. 4 allows the tool 10 to slide over a connector 120 and an attached linear member 100 in a direction either parallel or perpendicular to the engaging portion axis 41. Although the tool 10 in FIG. 4 is shown with 8 engaging surfaces 51a, the tool 10 may be provided such that the engaging portion 40 has 4 equally sized linear engaging surfaces (not shown) and the slot 50 comprises about 33% of the circumference of the engaging portion 40. The tool 10 may also be provided such that the engaging portion 40 has 10 equally sized linear engaging surfaces (not shown) and the slot 50 comprises about 17% of the circumference of the engaging portion 40.

In FIG. 5, the tool 10 is provided such that the engaging portion 40 has 5 equally sized linear engaging surfaces 51d and the slot 50 comprises about 17% of the circumference of the engaging portion 40. The engaging portion 40 shown in FIG. 5 allows the tool 10 to slide over a connector 120 in a direction parallel to the engaging portion axis 41 and an attached linear member 100 in a direction either parallel or perpendicular to the engaging portion axis 41.

The engaging portion 40 is shown based on 6 point and 12 point configurations; however, other configurations may be used with a slot 50 comprising about 17% to 33% of the circumference of the engaging portion 40. For instance, 4 point or 8 point configurations may be provided for engaging 4 point or 8 point connectors.

Optionally, the engaging surfaces 51a and 51b may also take the form of equally sized roughly V-shaped or U-shaped grooves or any other suitable shape (not shown). Such grooves allow for a better grip on the points of the connector 120. Further, optionally, two of the engaging surfaces adjacent to the slot 50 may have a shorter length than the other equally sized engaging surfaces so as to allow the fabricator of the tool 10 to form the slot 50 to any desirable size and accommodate any size linear member 100.

Generally speaking, the slot 50 should be of a size that permits a linear member 100, such as a water line 110, to pass through the slot 50. In the case of a tool 10 for attaching a water line 110 to a lavatory or sink by means of a connector 120, the slot 50 may be about 9/16″ when measured in a direction perpendicular to the engaging portion axis 41. As noted above, the slot 50 may comprise between about 17% and about 33% of the circumference of the engaging portion 40. For other uses, the slot 50 may be adapted to a different size, as needed.

The engaging portion 40 may be adapted to engage with any size connector using any standard, for example metric or English standard. In the specific case of a tool 10 for attaching a water line 110 to a sink by means of a connector 120, the engaging surfaces 51 should be adapted to fit a ¾″ connector. In the specific case of a tool 10 for attaching a water line 110 to a lavatory by means of a connector 120, the engaging surfaces 51 should be adapted to fit a 15/16″ connector.

As seen best in FIG. 2, the tool 10 may be provided such that the shaft axis 32 is offset from the engaging portion axis 41. When attaching a linear member 100 by means of a connector 120, it is desirable to have the shaft axis 32 offset from the engaging portion axis 41 so as to permit the linear member 100 to extend through the engaging portion 41 without interfering with the operation of the tool 10 in tightening and loosening the connector 120. The offset also permits the user of the tool to see the connector 120 prior to engaging the tool 10 with the connector 120.

As noted in detail above, the tool 10 may be provided such that the engaging portion 40 and engaging surfaces 51 are adapted to allow engagement with a standard sized connector 120. As noted in detail above, the tool 10 may be provided such that the first portion 47 of the opening 44 is adapted to fit a standard ratchet 130.

As seen best in FIGS. 2, 6 and 7, the tool 10 may be provided such that the opening 44 further comprises an inner portion 49 of the axially inner surface 45 which is located between the first portion 47 and the engaging surfaces 51, the inner portion 49 comprises a third opening area A3, and the third opening area A3 is smaller than the second opening area A2. It is desirable to provide that the third opening area A3 be smaller than the second opening area A2 to provide a seat 52 for the connector in the second end 43 of the engaging portion 40 while still providing enough space for the linear member 100 to pass through the engaging portion 40 in a direction parallel to the engaging portion axis 41. The seat 52 prevents the connector 120 from moving in a direction parallel to the engaging portion axis 41 during operation of the tool 10.

The intersection of any two engaging surfaces 51 may be referred to as a point 53. As seen in FIGS. 4 and 6, the tool 10 may be provided with the engaging portion 40 comprising any number of points 53 arranged in an arc about the engaging portion axis 41, in this case 7 points 53. As seen in FIGS. 5 and 7, the tool 10 may be provided with the engaging portion 40 comprising any number of points 53 arranged in an arc about the engaging portion axis 41, in this case 4 points 53.

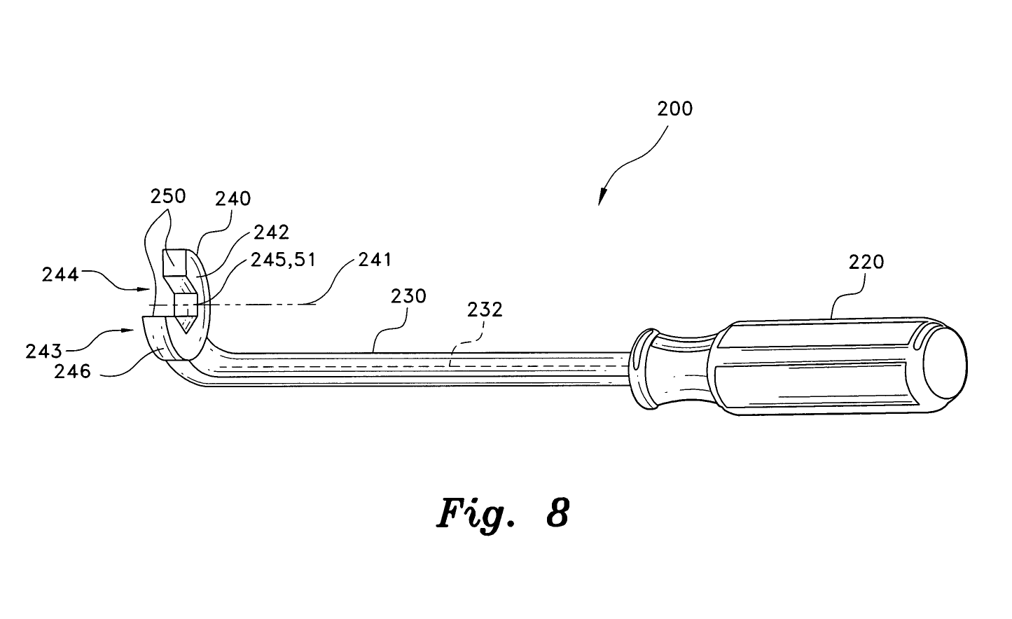

In another embodiment of the invention, as seen in FIG. 8, a tool 200 is provided which is substantially similar to the embodiment described above except that an engaging portion 240 has a shorter depth when measured in the direction parallel to the engaging portion axis 241 as compared to the embodiment described above. Similar structural elements are referred to with similar reference numerals except starting with 200.

The tool 200 comprises a handle 220, a shaft 230 comprising a shaft axis 232 connected to the handle 220, and an engaging portion 240 comprising an engaging portion axis 241, a first end 242 and a second end 243. The first end 242 is connected to the shaft 230, and the engaging portion 240 may have a substantially cylindrical shape. The engaging portion 240 comprises an opening 244 extending from the first end 242 to the second end 243 thereby defining an axially inner surface 245 of the engaging portion 240 and an axially outer surface 246 of the engaging portion 240. The engaging portion 240 comprises a slot 250 extending from the axially inner surface 245 to the axially outer surface 246. The axially inner surface 245 comprises a plurality of engaging surfaces 51.

The tool 200 may optionally have an engaging portion 240 with various geometries comprising various configurations of engaging surfaces 51a, 51b as seen best in FIGS. 4 and 5. The shaft 230 and the engaging portion 240 of the tool 200 may be of one-piece construction. The axially inner surface of the tool 200 may comprise any number of equally sized engaging surfaces 51. The shaft axis 232 of the tool 200 may be offset from the engaging portion axis 241. The engaging portion 240 and the engaging surfaces 51 of the tool 200 may be adapted to allow engagement with a standard sized connector 120. The engaging portion 240 of the tool 200 may comprise any number of points arranged in an arc about the engaging portion axis 241. The slot 250 of the tool 200 may be adapted to accommodate a linear member 100 attached to a connector 120. The slot 250 of the tool 200 may be adapted to accommodate a standard sized water line 110 for a sink or a lavatory (not shown) by means of a connector 120.

Although the tool 10, 200 is illustrated with either 8 equally sized engaging surfaces 51a (FIGS. 4 and 6) or with 5 equally sized engaging surfaces 51b (FIGS. 5 and 7) and in engagement with a 6-sided connector 120, it should be noted that the tool 10, 200 may be adapted with any number of engaging surfaces 51 and adapted to engage with any shape of connector 120.

In another embodiment of the present invention, the tool 10, 200 may be provided with an open-end wrench in lieu of the handle 20, 220, and the engaging portion 40, 240 may be provided such that the engaging portion axis 41, 241 is either parallel or perpendicular to the shaft axis 32, 232. This embodiment of the invention has been found to be particularly useful in plumbing applications.

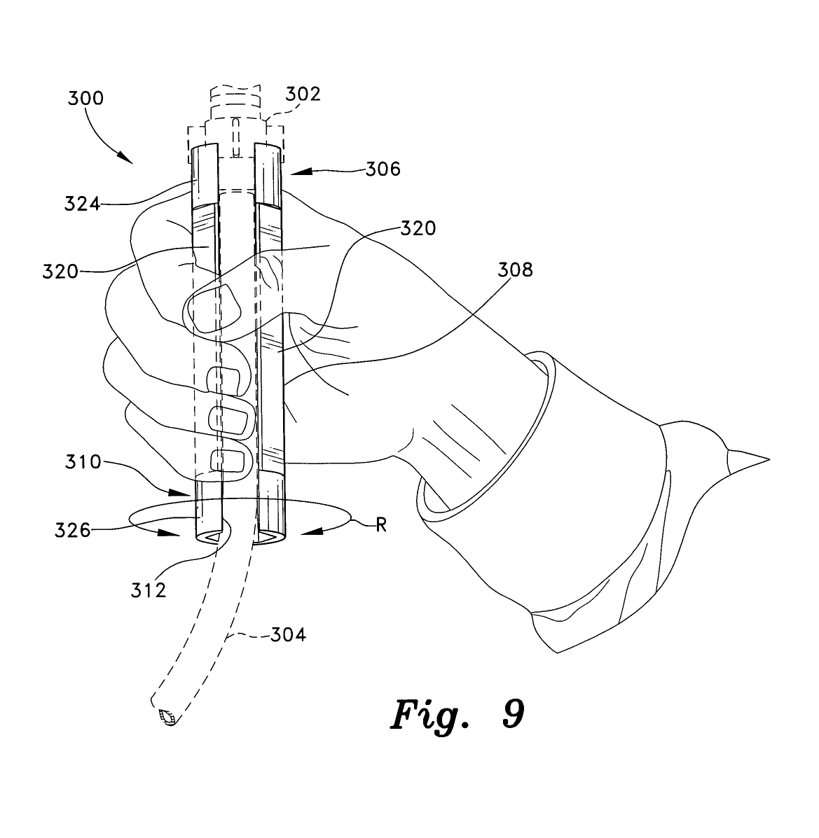

Those skilled in the art will appreciate that in certain situations, a smaller tool manipulated by hand would have access to areas where a longer tool with an extended handle would be unwieldy or impossible to position correctly. FIGS. 9-12 disclose an alternate embodiment of the present invention, described generally as 300 in the drawings, which is substantially similar to the embodiments described above except that the tool 300 is not encumbered by a handle and is comprised of a hollow cylindrical wrench of unitary construction formed from rigid plastic material, aluminum, or any rigid material capable of cooperatively engaging a multi-faceted connector 120. Similar structural elements are referred to with similar reference numerals, except that the numerals start with 300.

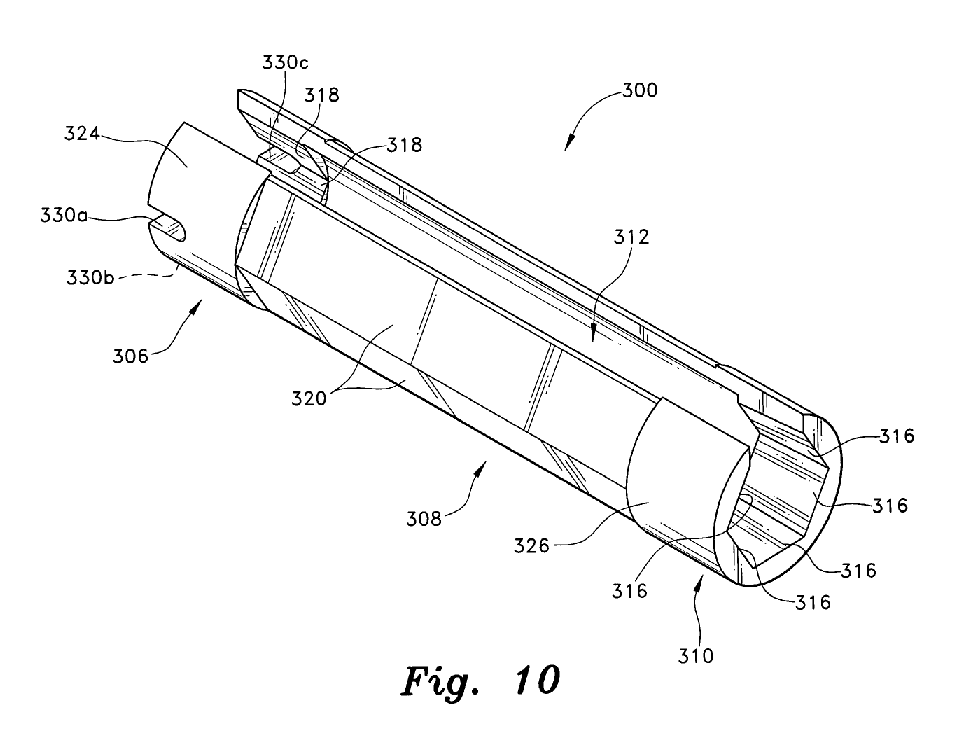

As shown in FIG. 9, one use of the tool 300 is to attach a roughly linear waterline 304 to a sink (not shown) by means of a wing nut connector 302. As best shown in FIG. 10, the tool 300 is a generally hollow cylinder, having a first end 306, a second end 310, and a slot 312 extending from the first end 306 to the second end 310, the slot being adapted to receive a linear waterline 304, thereby enabling either end 306, 310 to cooperatively engage a connector. The overall length of the embodiment of the tool 300 shown in FIGS. 9-12 for the specific purpose of attaching a water line 304 to a sink by means of a connector 302 may be 5″ to 8″.

The inner surface of each end 306, 310 is formed by a plurality of engaging surfaces 318, 316 adapted to receive a multi-faceted connector, extending approximately ¾″ inward from the end of the tool 300. Smooth outer surfaces 324, 326 are formed on each end 306, 310 of the tool 300; however, any suitable shape may be used. The center portion of the tool 300, approximately 5″ in length, has a plurality of flat engaging surfaces 320 extending along the outer surface of the tool 300, the surfaces 320 providing a gripping surface for the user's hand or capable of cooperatively engaging an open end wrench (not shown) should more torque be necessary to remove stubborn connectors. Although the present embodiment of the tool 300 has five engaging surfaces 320 spaced around the outer surface of the central portion 308 of the tool 300, the actual number of surfaces may be more or less than the five shown, the primary purpose of the flat surfaces 320 being to provide a non-uniform gripping surface.

As previously described in the previous embodiments 10, 200 of the tool, FIGS. 9 and 10 disclose a slot 312 disposed in the wall of the tool extending from the first end 306 to the second end 310 which should be of a size that permits a water line 304 to pass through the slot 312.

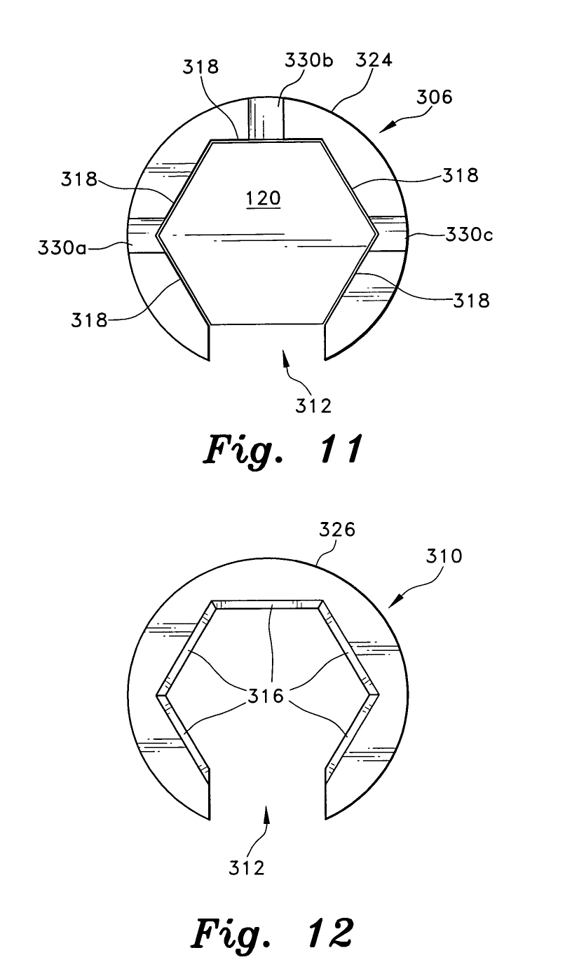

The engaging surfaces 318 on the inside surface of the first end 306 of the tool 300 may be adapted, as in the previous embodiments 10, 200 of the invention, to engage with any size connector using any standard. As shown in FIG. 11 of the present embodiment, which is adapted for the specific purpose of attaching a water line to a sink by means of a hexagonal connector 120, the engaging surfaces 318 should be adapted to fit a ¾″ connector.

For the specific purpose of attaching a water line 304 to a sink by means of wing nut 302, FIGS. 10 and 11 best illustrate three “U” shaped notches 330 cut in the cylindrical wall of the first end 306 of the tool 300, approximately ¼″ in length. The three notches 330 are spaced at 90-degree intervals around the circumference of the end 306 of the tool 300, two notches 330a, 330c diametrically opposite each other and notch 330b disposed directly opposite the midpoint of slot 312. Referring back to FIG. 9, in practice, notches 330a, 330c cooperatively engage wing nut 302, at which point the application of torque around rotational axis R would operate to remove or fasten nut 302.

In the specific case of a tool 300 for attaching a water line to a lavatory or other facility by means of a connector (not shown) having a plurality of tapered sides, the second end 310 of tool 300 has five engaging surfaces 316, tapering from 15/16″ at the end of the tool to ⅞″, approximately ¾″ from the second end 310 of the tool 300.

The outside diameter of the tool 300 may be approximately 1 5/16″; smaller or larger dimensions of the tool 300 may be provided for smaller or larger connectors, respectively.

It is to be understood that the present invention is not limited to the sole embodiments described above, but encompasses any and all embodiments within the scope of the following claims.

We claim:

1. A tool comprising:
a handle;
a shaft comprising a shaft axis connected to the handle; and
an engaging portion comprising an engaging portion axis, a first end and a second end;
wherein the first end is connected to the shaft;
wherein the engaging portion comprises an opening extending from the first end to the second end thereby defining an axial inner surface of the engaging portion and an axial outer surface of the engaging portion;
wherein the opening comprises a first portion at the first end with a first opening area and a second portion at the second end with a second opening area;
wherein the first opening area has a different shape than the second opening area;
wherein the engaging portion comprises a slot extending from the axially inner surface to the axial outer surface; and
wherein the second end of the axial inner surface comprises a plurality of engaging surfaces.

2. The tool according to claim 1, wherein said shaft and said engaging portion are of one-piece construction.

3. The tool according to claim 1, wherein said shaft axis is offset from said engaging portion axis.

4. The tool according to claim 1, wherein said engaging portion and engaging surfaces are adapted to allow engagement with a standard sized connector.

5. The tool according to claim 1, wherein said first portion of said opening is adapted to fit a standard ratchet.

6. The tool according to claim 1, wherein said opening further comprises an inner portion of said axial inner surface located between said first portion and said engaging surfaces, the inner portion comprising a third opening area smaller than said second opening area.

7. The tool according to claim 6, wherein said inner portion comprises a seat for a connector whereby the connector is prevented from moving in the direction parallel to said engaging portion axis.

8. The tool according to claim 1, wherein said engaging portion comprises a plurality of points arranged in an arc about said engaging portion axis.

9. The tool according to claim 1, wherein the slot is adapted to accommodate a linear member attached to a connector.

10. A tool comprising:
a generally hollow cylindrical wrench of one-piece construction, having an axial inner surface, an axial outer surface, a first end, a second end, a center portion, a slot extending from the first end to the second end, and a longitudinal axis having a length extending from the first end to the second end;
a first engaging portion disposed on the axial inner surface of the first end of the tool, the first engaging portion further comprising a plurality of axial engaging surfaces adapted to cooperative engage a multi-faceted connector;
a plurality of notches defined in the first end of the generally hollow cylindrical wrench, the notches extending from the axial inner surface to the axial outer surface; and
a second engaging portion disposed on the axial inner surface of the second end of the tool, the second engaging portion further comprising a plurality of tapered engaging surfaces, adapted for cooperatively engaging the tapered sides of a multi-faceted connector.

11. The tool according to claim 10, wherein the tool is of one-piece construction and about 7″ long.

12. The tool according to claim 10, wherein said first and second engaging portions and engaging surfaces are adapted for engaging a standard sized connector.

13. The tool according to claim 10, wherein said first engaging portion and said second engaging portion each has five engaging surfaces approximately ¾″ long.

14. The tool according to claim 10, wherein said slot is adapted to accommodate a substantially linear water line sized for a sink or a lavatory.

15. The tool according to claim 10, wherein the tapered engaging surfaces has an opening approximately 15/16″ at the second end of the tool, tapering to approximately ⅞″.

16. The tool according to claim 10, wherein the axial outer surface of said center portion has a plurality of flat surfaces spaced radially around said axial outer surface, the flat surfaces being adapted to cooperatively engage a standard open-end wrench.
